(19) United States
(12) Patent Application Publication
(10) Pub. No.: US 2025/0386812 A1
(43) Pub. Date: Dec. 25, 2025

(54) QUICK-ASSEMBLY FISH ATTRACTOR

(71) Applicant: Tyler J. Looney, Rhome, TX (US)

(72) Inventor: Tyler J. Looney, Rhome, TX (US)

(21) Appl. No.: 18/748,019

(22) Filed: Jun. 19, 2024

(51) Int. Cl. A01K 85/00

(52) U.S. Cl. CPC A01K 85/1811; A01K 85/005

(57) ABSTRACT

According to an aspect of the present invention, there is provided fish attractor, comprising: a bucket-shaped housing with an open top; a lid for the housing, wherein the lid can be secured on top of the housing member; and a plurality of holes in the lid configured for installation of pipe segments. According to another aspect, there is provided a method of deploying a fish attractor, comprising: removing a lid secured on a bucket-shaped housing with an open top; retrieving a roll of pipe from inside the housing; cutting the pipe into segments; installing the segments into a plurality of holes in the lid configured for installation of pipe segments; placing a weight inside the housing; and securing the lid on the housing.

### BACKGROUND

A number of prior art patent disclosures relate to devices and systems for attracting fish.

For example, U.S. Pat. No. 9,474,262 further describes a tubular body with apertures to create a disturbance so as to attract fish, but the disclosed intent is also to try to prevent the described teaser device from skipping across the surface while being trolled.

U.S. Pat. Nos. 8,776,427 and 9,326,495 disclose a means of attaching an impeller to the output shaft of a motor so as to create rotational splashing as a suggested means to attract fish.

U.S. Pat. App. Pub. No. 20210195883 discloses a fish attracting device including a first rotating member configured to rotate about a first central axis in response to movement of the first rotating member relative to water, the first rotating member having at least one asymmetrical blade protrusion positioned to encourage rotation of the first rotating member relative to the water in response to the movement of the first rotating member relative to the water; and a second rotating member coupled to the first rotating member, the second rotating member being configured to rotate about a second central axis in response to movement of the second rotating member relative to the water, the second rotating member having an asymmetrical blade protrusion positioned to encourage rotation of the second rotating member relative to the water in response to the movement of the second rotating member relative to the water, the rotation of the second rotating member being substantially opposite the rotation of the first rotating member. The first rotating member can have a single asymmetrical blade protrusion, and the asymmetrical blade protrusion can be integrally formed on the first rotating member. The second rotating member can also have a single asymmetrical blade protrusion, and the asymmetrical blade protrusion can be integrally formed on the second rotating member.

However, prior art fish attractors suffer from limitations including high cost and inconvenience.

### SUMMARY OF INVENTION

Therefore, the present invention provides a fish attractor device that is easy to transport, can be mass produced, and can be quickly assembled onsite.

The fish attractor has two states of operation: an unassembled state for shipment, and an assembled state for deployment under water.

According to an aspect of the present invention, there is provided fish attractor, comprising: a bucket-shaped housing with an open top; a lid for the housing, wherein the lid can be secured on top of the housing member; and a plurality of holes in the lid configured for installation of pipe segments.

According to another aspect, there is provided a method of deploying a fish attractor, comprising: removing a lid secured on a bucket-shaped housing with an open top; retrieving a roll of pipe from inside the housing; cutting the pipe into segments; installing the segments into a plurality of holes in the lid configured for installation of pipe segments; placing a weight inside the housing; and securing the lid on the housing.

### BRIEF DESCRIPTION OF THE DRAWINGS

FIG. 1 illustrates an embodiment of the present invention in an unassembled state.

FIG. 2 illustrates an embodiment of the present invention in an assembled state.

### DETAILED DESCRIPTION

Fish attractors have been used under water to help improve the ecosystem and enhance the recreational fishing experience. Fish attractors provide cover for sportfish as well as forage species such as insects, crustaceans and minnows that sportfish depend upon for food. Fish are attracted to brush piles or other structure in search of forage and protection from predators. Fish attractors often function by replicating the shelters fish naturally seek.

Traditional fish attractors are often custom built, and have high assembly cost and raw material cost for rock piles, plastic pipe, concrete culverts and the like.

A fish attractor is usually made out of metal bars or PVC pipes attached to a center structure, which is in turn attached to a heavy base so that it can sink to the bottom of the water and stay stationary. The metal bars, PVC pipes, and heavy base make the fish attractor hard to transport over long distances, and difficult to mass produce.

The present invention provides a more convenient and less expensive solution. Embodiments of the present invention will be described with reference to the attached drawings.

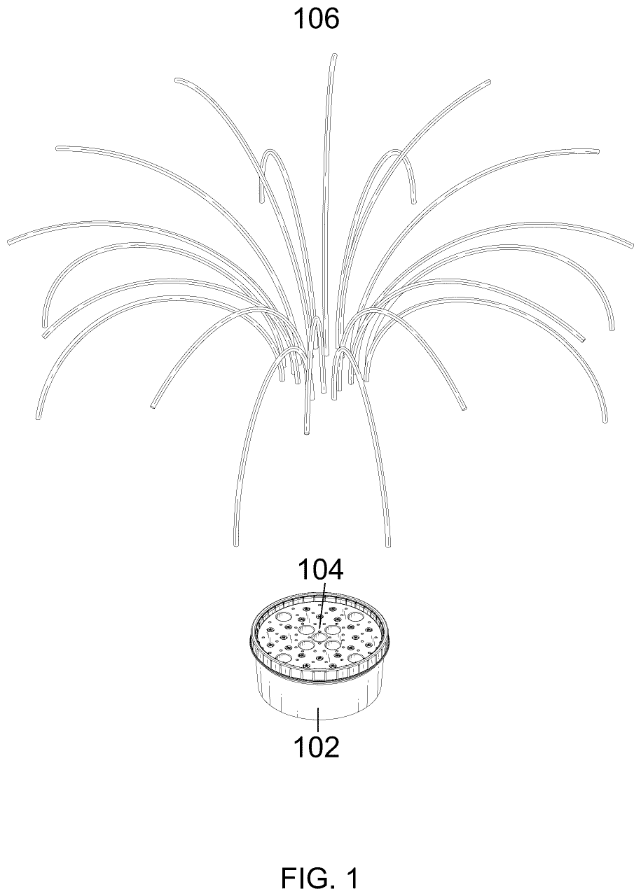

FIG. 1 illustrates an embodiment of the present invention in an unassembled state.

In the unassembled state, the fish attractor has a bucket shaped housing member 102, and a lid member attached securely onto the housing 104, and pipe 106.

Pipe 106 can be flexible and stored in a roll inside the housing for easy transport of the unassembled fish attractor.

Lid 104 has a plurality of holes configured for installation of pipe segments.

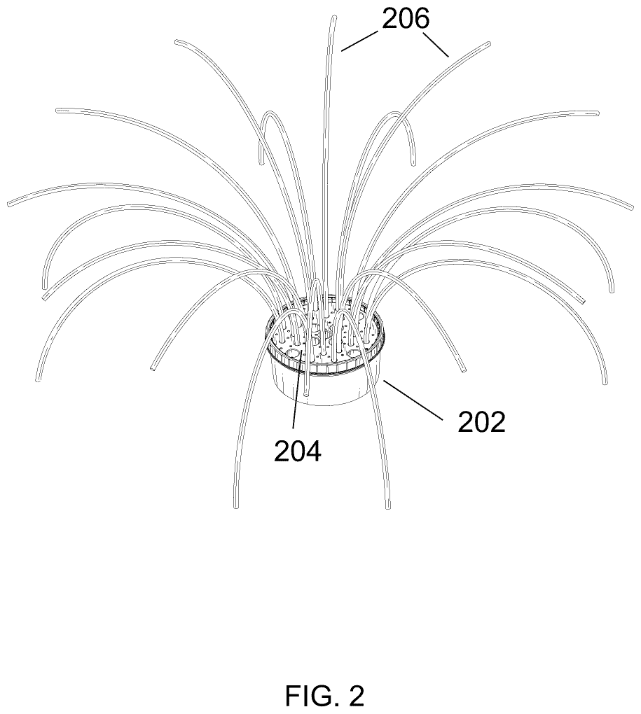

FIG. 2 illustrates an embodiment of the present invention in an assembled state.

In the assembled state, the roll of pipe has been taken out of the housing 202, cut into sections 206, and installed on top of the lid 204 poking outward in a variety of directions.

After the pipe is installed, weights are put inside the housing 202, and the lid 204 with the pipes 202 sticking out is securely attached back to the housing.

The illustrations of embodiments described herein are intended to provide a general understanding of the structure of various embodiments, and they are not intended to serve as a complete description of all the elements and features of apparatus and systems that might make use of the structures described herein.

Many other embodiments will be apparent to those of skill in the art upon reviewing the above description. Other embodiments may be utilized and derived therefrom, such that structural and logical substitutions and changes may be made without departing from the scope of this disclosure.

Figures are also merely representational and may not be drawn to scale. Similar numerals designate similar elements among the several figures. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown.

This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A fish attractor, comprising:
a bucket-shaped housing with an open top;
a lid for the housing, wherein the lid can be secured on top of the housing member; and
a plurality of holes in the lid configured for installation of pipe segments.

2. The fish attractor of claim 1, further comprising weights put inside the housing.

3. The fish attractor of claim 1, further comprising a roll of flexible pipe.

4. A method of deploying a fish attractor, comprising:
removing a lid secured on a bucket-shaped housing with an open top;
retrieving a roll of pipe from inside the housing;
cutting the pipe into segments;
installing the segments into a plurality of holes in the lid configured for installation of pipe segments;
placing a weight inside the housing; and
securing the lid on the housing.
